(19) United States
(12) Patent Application Publication
(10) Pub. No.: US 2016/0097457 A1
(43) Pub. Date: Apr. 7, 2016

(54) Self-pumping hydrodynamic mechanical seal

(71) Applicant: NANJING FORESTRY UNIVERSITY, Jiangsu (CN)

(72) Inventors: Jiajun Sun, Nanjing, Jiangsu (CN); Qiong Hu, Nanjing, Jiangsu (CN); Min Zhou, Nanjing, Jiangsu (CN); Qiaoan Tu, Nanjing, Jiangsu (CN); Chenbo Ma, Nanjing, Jiangsu (CN); Bo Yu, Nanjing, Jiangsu (CN)

(21) Appl. No.: 14/894,487

(22) PCT Filed: Apr. 21, 2014
(86) PCT No.: PCT/CN2014/075791

§ 371 Date: Nov. 27, 2015

(30) Foreign Application Priority Data
May 28, 2013 (CN) 201310201473.3

(51) Int. Cl. F16J 15/34; F16J 15/00

(52) U.S. Cl. CPC F16J 15/3412; F16J 15/002

(57) ABSTRACT

A self-pumping hydrodynamic mechanical seal includes a rotating ring (3) and a stationary ring (11). More than three sets of backward curved grooves (39) are provided on a seal face of the rotating ring (3), outlets of the backward curved grooves (39) are provided at an external diameter portion of the seal face of the rotating ring (3), and an inlet (31) connects with a seal chamber (1) through a duct (30) of the rotating ring (3) or the stationary ring (11). When the rotating ring (3) rotates, a medium in the backward curved grooves (39) is accelerated into a high-speed fluid; under a centrifugal force, the high-speed fluid moves to an external diameter side of the rotating ring (3), so as to be pumped into the seal chamber (1) and generates a low-pressure area at the inlets (31) of the backward curved grooves (39); the medium in the seal chamber (1) is driven by a pressure difference, so as to flow into the backward curved grooves (39) through the duct (30), for forming circulation of self-pumping. During pumping the high-speed fluid, a flow speed of the high-speed fluid is slowed and a pressure of the high-speed fluid is increased, as a flow sectional area of the backward curved grooves (39) is increased, so as to generate an opening force which separates the rotating ring (3) from the stationary ring (11). The seal has desirable capabilities of self-lubrication, self-flushing, solid particle interference resistance, and optimal sealing performance.

### CROSS REFERENCE OF RELATED APPLICATION

This is a U.S. National Stage under 35 U.S.C 371 of the International Application PCT/CN2014/075791, filed Apr. 21, 2014, which claims priority under 35 U.S.C. 119(a-d) to CN 201310201473.3, filed May 28, 2013.

### BACKGROUND OF THE PRESENT INVENTION

1. Field of Invention

The present invention belongs to the field of sealing technology, and more particularly, deals with a self-pumping mechanical seal with hydrodynamic effect, which is applicable to various sealing shafts of rotating machinery such as compressors, centrifugal pumps and agitators of reaction still.

2. Description of Related Arts

Conventionally, non-contacting mechanical end face seal, which is widely used on equipment such as compressors, fans and centrifugal pumps in petroleum, chemical, chemical fiber, paper, power and metallurgical industries, is formed by drilling a groove on a sealing surface of the rotating ring, wherein a fluid dynamic wedge is formed according to fluid dynamics, which generates an end face opening force, so as to reduce the wear of seal faces. For example, U.S. Pat. No. 4,212,475 discloses a non-contacting mechanical seal with a single helical groove, which combines fluid dynamic and static pressure; Chinese patent ZL00239203.8 discloses a single-groove upstream pumping mechanical seal; and Chinese patent ZL201020106087.8 discloses a centrifuge dry gas seal. According to the above patents, no matter the dry gas seal or the upstream pumping mechanical seal, the medium for forming fluid dynamic pressure is pumped into the groove. While generating an end face opening force at a bottom of the groove, separating a rotating ring from a stationary ring, and reducing the friction of seal end face, a leakage rate between the rotating ring and the stationary ring is increased. Especially if the pumping medium comprises grains, the end face of the seal dam will be damaged, which accelerates the failure of sealing. Therefore, some conventional techniques are improved. For example, U.S. Pat. No. 5,201,531 discloses a hydrodynamic end face seal with double spiral grooves; Chinese patent ZL96108614.9 discloses an end face seal with double rings and a spiral groove; and Chinese patent ZL00239202.X discloses a non-contacting mechanical seal with double fluid grooves and self-lubrication; which all effectively reconcile the contradiction. With a given rotation direction, such seals utilize one spiral groove for pumping sealing fluid to the downstream, and utilize another spiral groove for pumping sealing fluid to the upstream, wherein pump pressure difference generated by the spiral grooves are balanced with fluid pressure difference between internal and external sides of the seal end face, so as to achieve zero leakage of the spiral groove end face seal. However, such seals are complicated, need a large installation space, and are only suitable for small fluid pressure difference between the two sides of the seal end face.

### SUMMARY OF THE PRESENT INVENTION

An object of the present invention is to provide a pumping mechanical seal with hydrodynamic effect, which is suitable for a wide range of fluid pressure difference on both sides of a seal end face, so as to solve problems of a conventional single spiral groove mechanical seal that an end face opening force is small, a leakage rate is high, and particle interference resistance is poor; and problems of a conventional double spiral grooves mechanical seal that a seal end face structure is complicated, and an installation space is large. Compared with the above seals, the present invention has greater flexibility and zero leakage under same conditions.

Accordingly, in order to accomplish the above object, the present invention provides:

a self-pumping hydrodynamic mechanical seal, provided between a shell 2 of a rotating machinery and a shaft 10 or a shaft sleeve 8, wherein the self-pumping hydrodynamic mechanical seal comprises a rotating ring 3; an O-ring for the rotating ring 12; a stationary ring 11; an O-ring for the stationary ring 5; a spring 7; and a stationary ring holder 14; wherein: an end face of the rotating ring, which fits with the stationary ring 11, comprises a groove area and a seal dam 37; the groove area is arranged at an outer portion of the end face, while the seal dam 37 is arranged at an inner portion of the end face; more than three sets of backward curved grooves 39 are provided on the groove area, seal faces between the backward curved grooves 39 form seal weirs;

outlets of the backward curved grooves 39 are provided at an external diameter portion of a seal face of the rotating ring 3, inlets 31 of the backward curved grooves 39 connects with a seal chamber 1 through a duct 30 of the rotating ring 3 or the stationary ring 11;

a first side groove wall of the backward curved grooves 39 is a working face 34, a second side groove wall of the backward curved grooves 39 is a non-working face 35;

when the rotating ring 3 rotates, a medium in the backward curved grooves 39 is accelerated into a high-speed fluid by the working face 34 of the backward curved grooves 39; under a centrifugal force, the high-speed fluid moves to an external diameter side of the rotating ring 3 along the non-working face 35, so as to be pumped into the seal chamber 1 and generates a low-pressure area at the inlets 31 of the backward curved grooves 39; the medium in the seal chamber 1 is driven by a pressure difference, so as to flow into the backward curved grooves 39 through the duct 30, which connects with the seal chamber 1, of the rotating ring 3 or the stationary ring 11, forming the circulation of self-pumping; wherein on one hand, the circulation of self-pumping achieve a self-lubricating of the mechanical seal; on the other hand, continuous circulation of the fluid between the seal faces take away frictional heat therebetween in time, so as to achieve self-flushing; furthermore, the centrifugal force increases a power driving the fluid flow outwards the seal face of the rotating ring 3, reducing a leakage rate that the fluid flows inwards the seal face of the rotating ring 3; especially, with an effect of the centrifugal force, solid particles in the sealed fluid in the backward curved grooves 39 are separated from a matrix, wherein high density solid particles bears larger centrifugal force, and are pumped out with the fluid and sent into the seal chamber 1 instead of the seal dam 37, avoiding abrasive wear between the seal faces;

during pumping the high-speed fluid, which is accelerated by the working face 34 of the backward curved grooves 39, out of the backward curved grooves 39, a flow speed of the high-speed fluid is slowed and a pressure of the high-speed fluid is increased, as a flow sectional area of the backward curved grooves 39 is increased, so as to generate an opening force which separates the rotating ring 3 from the stationary ring 11.

According to the above self-pumping hydrodynamic mechanical seal, modeled lines of the groove wall on both sides of the backward curved grooves 39 are spiral lines; the spiral lines, which are the modeled lines of the groove walls on both sides of the backward curved grooves 39, have same spiral angles. Or, the spiral lines, which are the modeled lines of the groove walls on both sides of the backward curved grooves 39, have different spiral angles, wherein the spiral angle of the working face 34 is smaller than the spiral angle of the non-working face 35.

According to the above self-pumping hydrodynamic mechanical seal, the spiral lines, which are the modeled lines of the groove walls on both sides of the backward curved grooves 39, are tangent with circular holes of the inlets 31.

According to the above self-pumping hydrodynamic mechanical seal, the duct 30 is provided on the rotating ring 3, a cross section of a joint portion of the duct 30 and an external round face of the rotating ring 3 is a wedge-shaped opening 38, a rotation direction of the rotating ring 3 is same with a width decreasing direction of the wedge-shaped opening 38; or the duct 30 is provided on the stationary ring 11. Preferably, a loop groove 46 opposite to the inlets 31 of the backward curved grooves 39 is provided on a seal face of the stationary ring 11, the loop groove 46 connects with the seal chamber 1 through the duct 30 on the stationary ring 11.

According to the above self-pumping hydrodynamic mechanical seal, the inlets 31 of the backward curved grooves 39 connects with a loop groove 36 on the seal face of the rotating ring 3, the loop groove 36 connects with the seal chamber 1 through the duct 30. The loop groove 36 has effects such as collecting the medium of self-lubricating and self-flushing, preventing the pumping medium from being non-uniform, and preventing the occurrence of cavitation when fluid supplement is not in time at the inlets 31 of the backward curved grooves 39. Preferably, the duct 30 is provided on the stationary ring 11, an outlet of the duct 30 is provided on a seal face of the stationary ring 11 and is opposite to the loop groove 36.

According to the above self-pumping hydrodynamic mechanical seal, each of the backward curved grooves 39 comprises a slope groove 32 and a flat groove 33, wherein the slope groove 32 is provided at a large radius portion of the end face of the rotating ring, the flat slope groove 33 is provided at a small radius portion of the end face of the rotating ring. When an angle t between the slope groove 32 of the backward curved grooves 39 and the end face is 0 or Rp=R2, an isobathic groove is provided; when Rp=Ro the single slope groove 32 is provided. By changing numbers and parameters of the backward curved grooves 39, seal requirements of different seal media are satisfied.

According to the above self-pumping hydrodynamic mechanical seal, the duct 30 is provided on the rotating ring 3, and the duct 30 is parallel to the axis of the rotating ring 3.

According to the above self-pumping hydrodynamic mechanical seal, the duct 30 is an axial-radial-combined duct. The axial-radial-combined duct may be a multi-section combined duct wherein each section extends axially or radially, a duct which forms a certain angle larger than 0 degree and less than 90 degrees with an axial direction, or other axial-radial-combined duct, as long as the duct 30 connects backward curved grooves 39 and the seal chamber 1.

Beneficial effects of the present invention are as follows.

1) Sealing performance is excellent, which is suitable for sealing shafts of centrifugal pumps, centrifugal compressors, mixing equipment and other rotating machinery, which transporting various flammable, explosive, toxic fluid etc.; so as to provide no microscopic leakage of the sealing fluid.

2) When the rotating ring rotates, different quality particles bear different centrifugal forces, in such a manner that according to the present invention, the self-pumping hydrodynamic mechanical seal automatically removes the solid particles and avoids abrasive wear of the seal dam.

3) Application scope is wide, both liquid and gas are able to be sealed.

4) Unique functions of self-lubricating, self-cooling and self-flushing ensure the stability and durability of the mechanical seal.

5) Under a static state, the high-pressure side fluid is directly injected into the seal interface, which eliminates solid friction of the interface at a starting moment and rapidly form a fluid film separating the seal faces at the starting moment; therefore, the seal is also suitable for shaft seal of a rotating machinery which is frequently opened and stopped.

6) Because the high-pressure separation fluid comes from the sealed medium, no delivery system for the high-pressure separation fluid is needed, which reduces operating costs of the pump, and correspondingly increases economic efficiency.

### BRIEF DESCRIPTION OF THE DRAWINGS

FIG. 1 is an axial sectional view of a self-pumping hydrodynamic mechanical seal whose backward curved grooves connect with a seal chamber through an axial duct on a rotating ring.

FIG. 2 is a sketch view of an end face of the rotating ring with the backward curved grooves provided thereon.

FIG. 3 is an axial sectional view of a self-pumping hydrodynamic mechanical seal whose backward curved grooves connect with a seal chamber through a loop groove and an axial-radial-combined duct on a rotating ring.

FIG. 4 is a sketch view of an end face of the rotating ring with the backward curved grooves and the loop groove provided thereon.

FIG. 5 is an A-A sectional view of the FIG. 3.

FIG. 6 is an axial sectional view of a self-pumping hydrodynamic mechanical seal whose backward curved grooves connect with a seal chamber through a loop groove and an axial-radial-combined duct on a stationary ring.

FIG. 7 is a sketch view of an end face of the rotating ring with the backward curved grooves and no axial or axial-radial-combined duct provided thereon.

FIG. 8 is a sketch view of the stationary ring with the loop groove and the axial-radial-combined duct provided thereon.

FIG. 9 is an axial sectional view of a self-pumping hydrodynamic mechanical seal whose backward curved grooves connect with a seal chamber through a loop groove on a rotating ring and an axial-radial-combined duct on a stationary ring.

FIG. 10 is a sketch view of an end face of the rotating ring with the backward curved grooves, the loop ring and no axial or axial-radial-combined duct provided thereon.

FIG. 11 is a sketch view of the stationary ring with the axial-radial-combined duct provided thereon.

### REFERENCE

R1—inner radius of seal end faces connecting with each other between rotating and stationary rings;

R2—outer radius of seal end faces connecting with each other between rotating and stationary rings;

Rp—radius of groove step;

Ro—position radius of groove inlet hole;

Rk—radius of groove inlet hole;

R3—inner radius of groove inlet loop groove;

R4—outer radius of groove inlet loop groove;

G—pump direction of fluid groove;

f—sprial angle;

h—depth of flat groove;

t—angle between slope groove face and end face;

w—rotation direction of rotating ring;

1—seal chamber; 2—shell; 3—rotating ring; 30—axial or axial—radial—combined duct; 31—inlet; 32—slope groove; 33—flat groove; 34—working face; 35—non-working face; 36—loop groove on rotating ring; 46—loop groove on stationary ring; 37—seal dam; 38—wedge-shaped opening; 39—backward curved groove; 4—O-ring; 5—O-ring for the rotating ring; 6—stop pin; 7—spring; 8—shaft sleeve; 9—first fixing bolt; 13—second fixing bolt; 10—shaft; 11—stationary ring; 12—O-ring for the stationary ring; 14—stationary ring holder; 15—seal weir.

### DETAILED DESCRIPTION OF THE PREFERRED EMBODIMENT

The present invention is further illustrated combined with the following drawings and embodiment.

### Preferred Embodiment 1

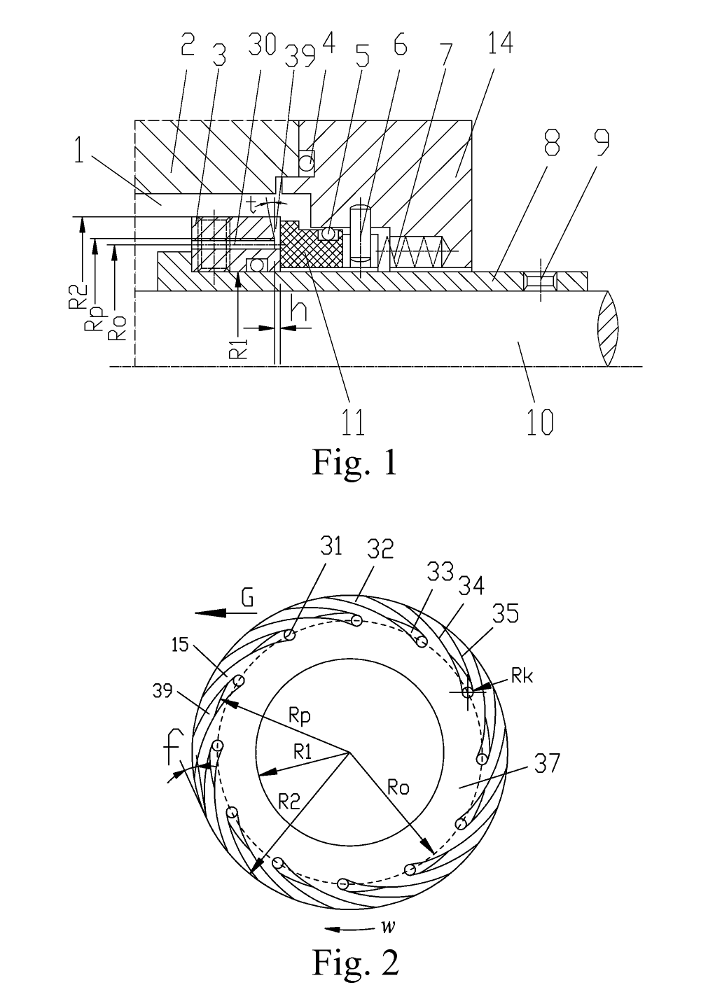

Referring to FIGS. 1 and 2, a self-pumping hydrodynamic mechanical seal is illustrated, which is provided between a shell 2 of a rotating machinery and a shaft 10 or a shaft sleeve 8, wherein the self-pumping hydrodynamic mechanical seal comprises a rotating ring 3; an O-ring for the rotating ring 12; a stationary ring 11; an O-ring for the stationary ring 5; a spring 7; and a stationary ring holder 14. An O-ring 4 is provided between the shell 2 and a stationary ring holder 14. The shaft sleeve 8 is mounted on the shaft 10 by a first fixing bolt 9. The rotating ring 3 is mounted on the shaft sleeve 8 by a second fixing bolt 13, and the O-ring for the rotating ring 12 is provided between the rotating ring 3 and the shaft sleeve 8. The stationary ring 11 is provided on the stationary ring holder 14, and the O-ring for the stationary ring 5 is provided between the stationary ring 11 and the stationary ring holder 14. A first end of a stop pin 6 is on the stationary ring holder 14, and a second end of the stop pin 6 extends into a guiding groove axially provided on the stationary ring 11. The stop pin 6 prevents the stationary ring 11 from rotating, and guides an axial movement of the stationary ring 11. The spring 7 is provided between the stationary ring 11 and the stationary ring holder 14, which pushes the stationary ring 11 to axially move under an abnormal condition, in such a manner that the stationary ring 11 closely contacts with the rotating ring 3.

A end face of the rotating ring, which fits with the stationary ring 11, comprises a groove area and a seal dam 37; the groove area is arranged at an outer portion of the end face, while the seal dam 37 is arranged at an inner portion of the end face; twelve sets of backward curved grooves 39 are provided on the groove area, seal faces between the backward curved grooves 39 form seal weirs 15;

wherein each of the backward curved grooves 39 comprises a slope groove 32 and a flat groove 33, wherein the slope groove 32 is provided at a large radius portion of the end face of the rotating ring, the flat slope groove 33 is provided at a small radius portion of the end face;

outlets of the backward curved grooves 39 are provided at an external diameter portion of a seal face of the rotating ring 3, inlets 31 are provided at a middle portion of the seal face of the rotating ring 3, the inlets 31 of the backward curved grooves 39 connects with a seal chamber 1 through a duct 30 of the rotating ring 3;

a first side groove wall of the backward curved grooves 39 is a working face 34, a second side groove wall of the backward curved grooves 39 is a non-working face 35;

when the rotating ring 3 rotates, a medium in the backward curved grooves 39 is accelerated into a high-speed fluid by the working face 34 of the backward curved grooves 39; under a centrifugal force, the high-speed fluid moves to an external diameter side of the rotating ring 3 along the non-working face 35, so as to be pumped into the seal chamber 1 and generates a low-pressure area at the inlets 31 of the backward curved grooves 39; the medium in the seal chamber 1 is driven by a pressure difference, so as to flow into the backward curved grooves 39 through the duct 30, which connects with the seal chamber 1 of the rotating ring 3, forming circulation of self-pumping; wherein on one hand, the continuous circulation of self-pumping achieve a self-lubricating of the mechanical seal; on the other hand, continuous circulation of the fluid between the seal faces take away frictional heat therebetween in time, so as to achieve self-flushing; furthermore, the centrifugal force increases a power driving the flow outwards the seal face of the rotating ring 3, reducing a leakage rate that the fluid flows inwards the seal face of the rotating ring 3; especially, with an effect of the centrifugal force, solid particles in the sealed fluid in the backward curved grooves 39 are separated from a matrix, wherein high density solid particles bears larger centrifugal force, and are pumped out with the fluid and sent into the seal chamber 1 instead of the seal dam 37, avoiding abrasive wear between the seal faces.

During pumping the high-speed fluid, which is accelerated by the working face 34 of the backward curved grooves 39, out of the backward curved grooves 39, a flow speed of the high-speed fluid is slowed and a pressure of the high-speed fluid is increased, as a flow sectional area of the backward curved grooves 39 is increased, so as to generate an opening force which separates the rotating ring 3 from the stationary ring 11.

Modeled lines of the groove walls on both sides of the backward curved grooves 39 are spiral lines.

The spiral lines, which are the modeled lines of the groove walls on both sides of the backward curved grooves 39, have same spiral angles f.

The spiral lines, which are the modeled lines of the groove walls on both sides of the backward curved grooves 39, are tangent with circular holes of the inlets 31.

### Preferred Embodiment 2

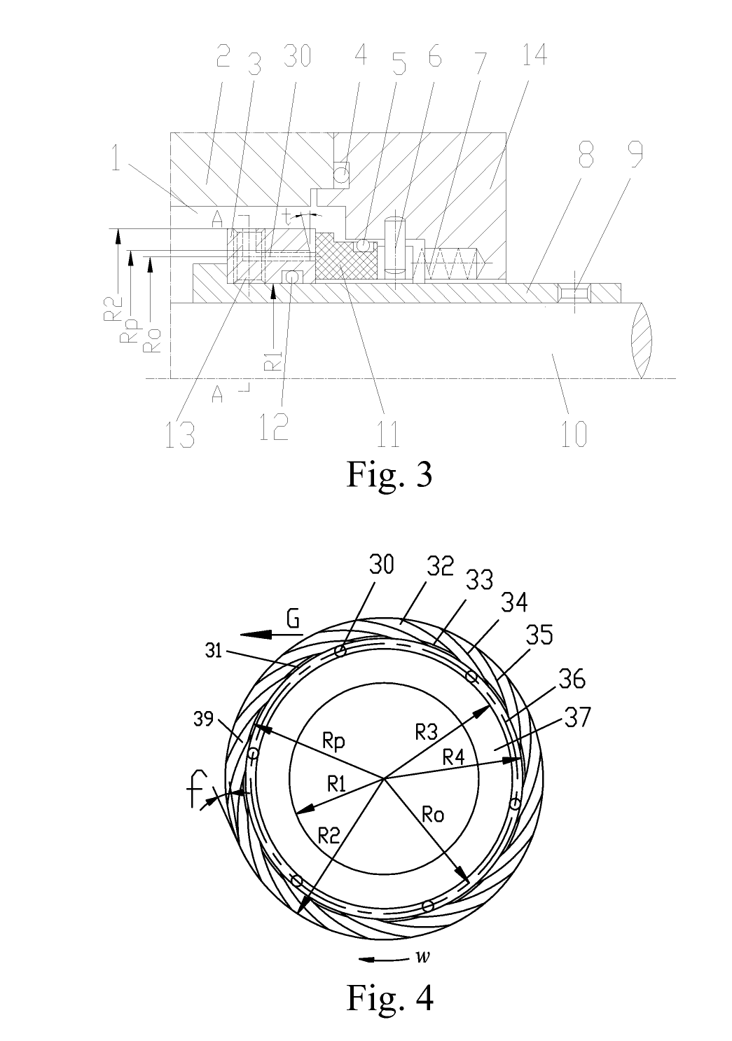

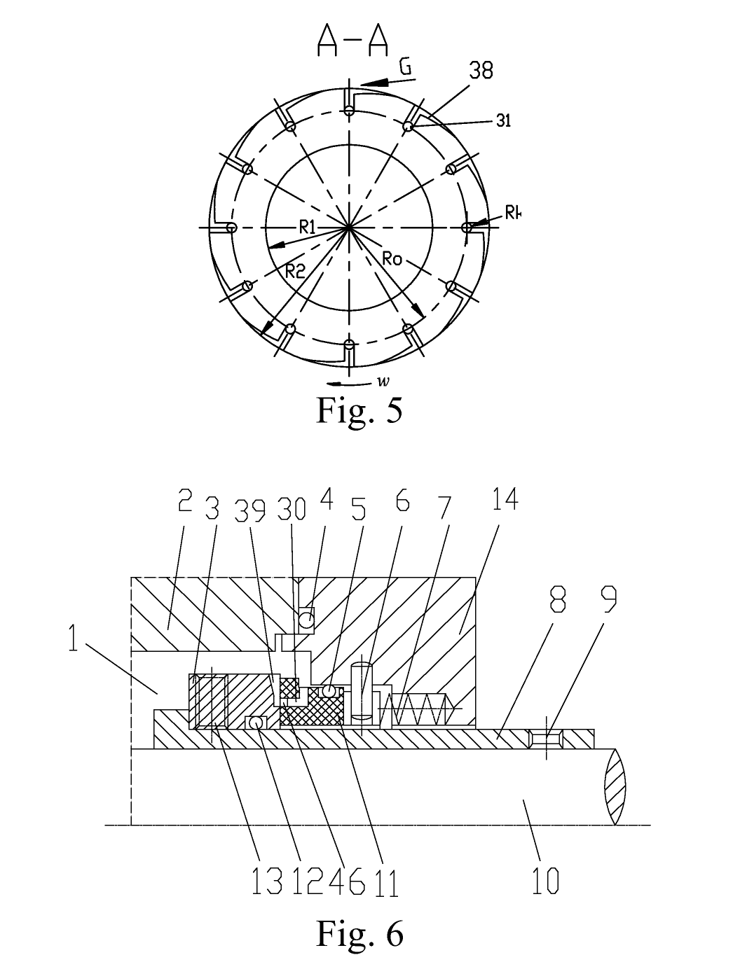

Referring to FIGS. 3-5, another self-pumping hydrodynamic mechanical seal is provided. Different from the preferred embodiment 1, the inlets 31 of the backward curved grooves 39 connects with a loop groove 36 at the middle portion of the seal face of the rotating ring 3, six axial-radial-combined ducts 30 connectting with the seal chamber 1 are provided on the loop groove 36; a cross section of a joint portion of the ducts 30 and an external round face of the rotating ring 3 is a wedge-shaped opening 38; the loop groove 36 has effects such as collecting the medium of self-lubricating and self-flushing, preventing the pumping medium from being non-uniform, and preventing the occurrence of cavitation when fluid supplement is not in time at the inlets 31 of the backward curved grooves 39.

Other structures of the preferred embodiment 2 are same as the preferred embodiment 1.

### Preferred Embodiment 3

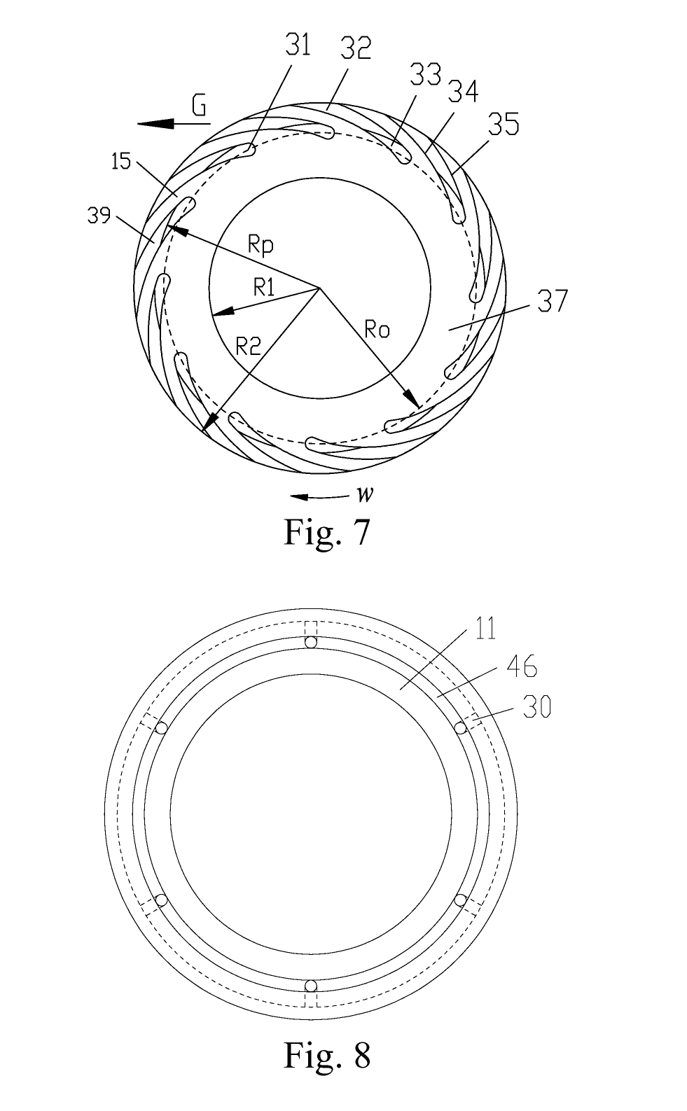

Referring to FIGS. 6-8, self-pumping hydrodynamic mechanical seal is illustrated, which is provided between a shell 2 of a rotating machinery and a shaft sleeve 8, wherein the self-pumping hydrodynamic mechanical seal comprises a rotating ring 3; an O-ring for the rotating ring 12; a stationary ring 11; an O-ring for the stationary ring 5; a spring 7; and a stationary ring holder 14. An O-ring 4 is provided between the shell 2 and a stationary ring holder 14. The shaft sleeve 8 is mounted on the shaft 10 by a first fixing bolt 9. The rotating ring 3 is mounted on the shaft sleeve 8 by a second fixing bolt 13, and the O-ring for the rotating ring 12 is provided between the rotating ring 3 and the shaft sleeve 8. The stationary ring 11 is provided on the stationary ring holder 14, and the O-ring for the stationary ring 5 is provided between the stationary ring 11 and the stationary ring holder 14. A first end of a stop pin 6 is on the stationary ring holder 14, and a second end of the stop pin 6 extends into a guiding groove axially provided on the stationary ring 11. The stop pin 6 prevents the stationary ring 11 from rotating, and guides an axial movement of the stationary ring 11. The spring 7 is provided between the stationary ring 11 and the stationary ring holder 14, which pushes the stationary ring 11 to axially move under an abnormal condition, in such a manner that the stationary ring 11 closely contacts with the rotating ring 3.

A rotating ring end face, which fits with the stationary ring 11, comprises a groove area and a seal dam 37; the groove area is arranged at an outer portion of the end face of the rotating ring, while the seal dam 37 is arranged at an inner portion of the end face; twelve sets of backward curved grooves 39 are provided on the groove area, seal faces between the backward curved grooves 39 form seal weirs 15;

wherein each of the backward curved grooves 39 comprises a slope groove 32 and a flat groove 33, wherein the slope groove 32 is provided at a large radius portion of the end face of the rotating ring, the flat slope groove 33 is provided at a small radius portion of the end face;

outlets of the backward curved grooves 39 are provided at an external diameter portion of a seal face of the rotating ring 3, inlets 31 of the backward curved grooves 39 connects with a seal chamber 1 through a loop groove 46 and six axial-radial-combined ducts 30 of the stationary ring 11; the loop groove 46 is provided on a seal face of the stationary ring 11 and is opposite to the inlets 31 of the backward curved grooves 39.

A first side groove wall of the backward curved grooves 39 is a working face 34, a second side groove wall of the backward curved grooves 39 is a non-working face 35;

when the rotating ring 3 rotates, a medium in the backward curved grooves 39 is accelerated into a high-speed fluid by the working face 34 of the backward curved grooves 39; under a centrifugal force, the high-speed fluid moves to an external diameter side of the rotating ring 3 along the non-working face 35, so as to be pumped into the seal chamber 1 and generates a low-pressure area at the inlets 31 of the backward curved grooves 39; the medium in the seal chamber 1 is driven by a pressure difference, so as to flow into the backward curved grooves 39 through the axial-radial-combined ducts 30 and the loop groove 46 of the stationary ring 11 for forming circulation of self-pumping. The loop groove 46 has effects such as collecting the medium of self-lubricating and self-flushing, preventing the pumping medium from being non-uniform, and preventing the occurrence of cavitation when fluid supplement is not in time at the inlets 31 of the backward curved grooves 39. On one hand, the circulation of self-pumping achieve a self-lubricating of the mechanical seal; on the other hand, continuous circulation of the fluid between the seal faces take away frictional heat therebetween in time, so as to achieve self-flushing; furthermore, the centrifugal force increases a power driving the flow outwards the seal face of the rotating ring 3, reducing a leakage rate that the fluid flows inwards the seal face of the rotating ring 3; especially, with an effect of the centrifugal force, solid particles in the sealed fluid in the backward curved grooves 39 are separated from a matrix, wherein high density solid particles bears larger centrifugal force, and are pumped out with the fluid and sent into the seal chamber 1 instead of the seal dam 37, avoiding abrasive wear between the seal faces.

During pumping the high-speed fluid, which is accelerated by the working face 34 of the backward curved grooves 39, out of the backward curved grooves 39, a flow speed of the high-speed fluid is slowed and a pressure of the high-speed fluid is increased, as a flow sectional area of the backward curved grooves 39 is increased, so as to generate an opening force which separates the rotating ring 3 from the stationary ring 11.

Modeled lines of the groove walls on both sides of the backward curved grooves 39 are spiral lines.

The spiral lines, which are the modeled lines of the groove walls on both sides of the backward curved grooves 39, have same spiral angles f.

The spiral lines, which are the modeled lines of the groove walls on both sides of the backward curved grooves 39, are tangent with circular holes of the inlets 31.

### Preferred Embodiment 4

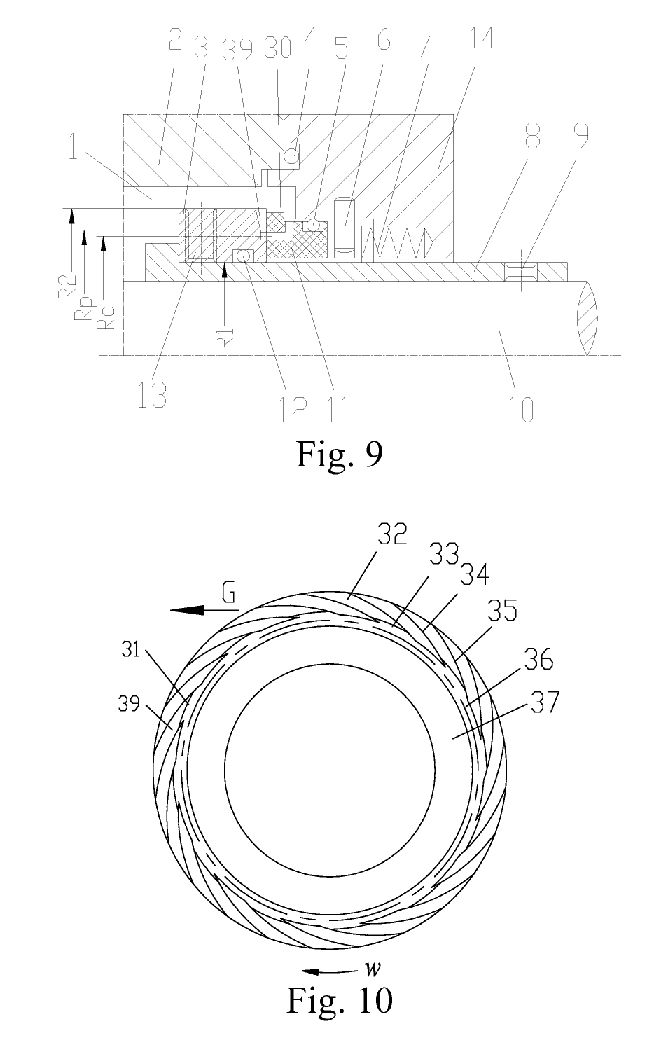

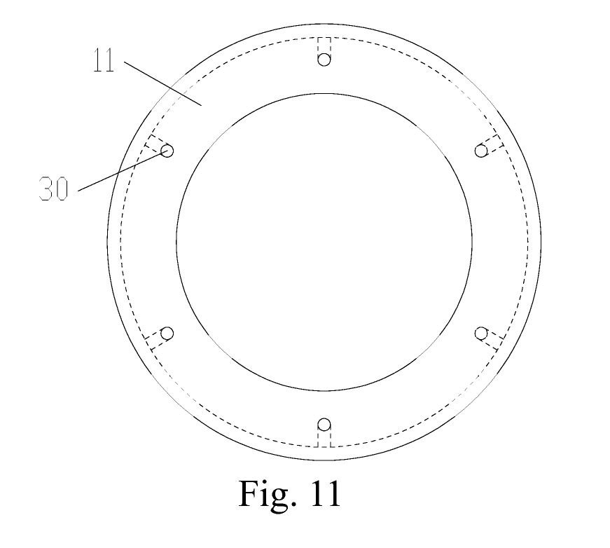

Referring to FIGS. 9-11, another self-pumping hydrodynamic mechanical seal is provided. Different from the preferred embodiment 3, a loop groove 36 is provided on the end face of the rotating ring, and there is no loop groove on the end face of the stationary ring. The inlets 31 of the backward curved grooves 39 connect with the loop groove 36, and the loop groove 36 is opposite to openings of the six axial-radial-combined ducts 30 in an axial direction. The inlets 31 of the backward curved grooves 39 connect with the seal chamber 1 through the loop groove 36 and the axial-radial-combined ducts 30 of the stationary ring 11. When the rotating ring 3 rotates, a medium in the backward curved grooves 39 is accelerated into a high-speed fluid by the working face 34 of the backward curved grooves 39; under a centrifugal force, the high-speed fluid moves to an external diameter side of the rotating ring 3 along the non-working face 35, so as to be pumped into the seal chamber 1 and generates a low-pressure area at the inlets 31 of the backward curved grooves 39; the medium in the seal chamber 1 is driven by a pressure difference, so as to flow into the backward curved grooves 39 through the axial-radial-combined ducts 30 and the loop groove 36 of the stationary ring 11, forming circulation of self-pumping. The loop groove 46 has effects such as collecting the medium of self-lubricating and self-flushing, preventing the pumping medium from being non-uniform, and preventing the occurrence of cavitation when fluid supplement is not in time at the inlets 31 of the backward curved grooves 39.

Other structures of the preferred embodiment 4 are same as the preferred embodiment 3.

1: A self-pumping hydrodynamic mechanical seal, provided between a shell (2) of a rotating machinery and a shaft (10) or a shaft sleeve (8), wherein the self-pumping hydrodynamic mechanical seal comprises a rotating ring (3); an 0-ring for the rotating ring(12); a stationary ring (11); an 0-ring for the stationary ring(5); a spring (7); and a stationary ring holder (14); wherein:
an end face of the rotating ring, which fits with the stationary ring (11), comprises a groove area and a seal dam (37); the groove area is arranged at an outer portion of the end face of the rotating ring, while the seal dam (37) is arranged at an inner portion of the end face; more than three sets of backward curved grooves (39) are provided on the groove area, seal faces between the backward curved grooves (39) form seal weirs;
outlets of the backward curved grooves (39) are provided at an external diameter portion of a seal face of the rotating ring (3), inlets (31) of the backward curved grooves (39) connects with a seal chamber (1) through a duct (30) of the rotating ring (3) or the stationary ring (11);
a first side groove wall of the backward curved grooves (39) is a working face (34), a second side groove wall of the backward curved grooves (39) is a non-working face (35);
when the rotating ring (3) rotates, a medium in the backward curved grooves (39) is accelerated into a high-speed fluid by the working face (34) of the backward curved grooves (39); under a centrifugal force, the high-speed fluid moves to an external diameter side of the rotating ring (3) along the non-working face (35), so as to be pumped into the seal chamber (1) and generates a low-pressure area at the inlets (31) of the backward curved grooves (39); the medium in the seal chamber (1) is driven by a pressure difference, so as to flow into the backward curved grooves (39) through the duct (30), which connects with the seal chamber (1), of the rotating ring (3) or the stationary ring (11), forming circulation of self-pumping;
during pumping the high-speed fluid, which is accelerated by the working face (34) of the backward curved grooves (39), out of the backward curved grooves (39), a flow speed of the high-speed fluid is slowed and a pressure of the high-speed fluid is increased, as a flow sectional area of the backward curved grooves (39) is increased, so as to generate an opening force which separates the rotating ring (3) from the stationary ring (11).

2: The self-pumping hydrodynamic mechanical seal, as recited in claim 1, wherein modeled lines of the groove walls on both sides of the backward curved grooves (39) are spiral lines.

3: The self-pumping hydrodynamic mechanical seal, as recited in claim 2, wherein the spiral lines, which are the modeled lines of the groove walls on both sides of the backward curved grooves (39), have same spiral angles.

4: The self-pumping hydrodynamic mechanical seal, as recited in claim 2, wherein the spiral lines, which are the modeled lines of the groove walls on both sides of the backward curved grooves (39), have different spiral angles, wherein the spiral angle of the working face (34) is smaller than the spiral angle of the non-working face (35).

5: The self-pumping hydrodynamic mechanical seal, as recited in claim 2, wherein the spiral lines, which are the modeled lines of the groove walls on both sides of the backward curved grooves (39), are tangent with circular holes of the inlets (31).

6: The self-pumping hydrodynamic mechanical seal, as recited in claim 1, wherein the duct (30) is provided on the rotating ring (3), a cross section of a joint portion of the duct (30) and an external round face of the rotating ring (3) is a wedge-shaped opening (38), a rotation direction of the rotating ring (3) is same with a width decreasing direction of the wedge-shaped opening (38).

7: The self-pumping hydrodynamic mechanical seal, as recited in claim 1, wherein the duct (30) is provided on the stationary ring (11).

8: The self-pumping hydrodynamic mechanical seal, as recited in claim 7, wherein a loop groove (46) opposite to the inlets (31) of the backward curved grooves (39) is provided on a seal face of the stationary ring (11), the loop groove (46) connects with the seal chamber (1) through the duct (30) on the stationary ring (11).

9: The self-pumping hydrodynamic mechanical seal, as recited in claim 1, wherein the inlets (31) of the backward curved grooves (39) connects with a loop groove (36) on the seal face of the rotating ring (3), the loop groove (36) connects with the seal chamber (1) through the duct (30).

10: The self-pumping hydrodynamic mechanical seal, as recited in claim 9, wherein the duct (30) is provided on the stationary ring (11), an outlet of the duct (30) is provided on a seal face of the stationary ring (11) and is opposite to the loop groove (36).

11: (canceled)

12: The self-pumping hydrodynamic mechanical seal, as recited in claim 1, wherein each of the backward curved grooves (39) comprises a slope groove (32) and a flat groove (33), wherein the slope groove (32) is provided at a large radius portion of the end face of the rotating ring, the flat slope groove (33) is provided at a small radius portion of the end face.

13: The self-pumping hydrodynamic mechanical seal, as recited in claim 1, wherein the duct provided on the rotating ring (3), and the duct (30) is parallel to the axis of the rotating ring (3).

14: The self-pumping hydrodynamic mechanical seal, as recited in claim 1, wherein the duct (30) is an axial-radial-combined duct.
